(19) United States
(12) Patent Application Publication
(10) Pub. No.: US 2024/0009912 A1
(43) Pub. Date: Jan. 11, 2024

(54) METHOD OF MANUFACTURING A USABLE CONTAINER CONSISTING OF A STIFF OUTER CONTAINER AND A DEFORMABLE INNER BAG

(71) Applicant: Gaplast GmbH, Altenau (DE)

(72) Inventors: Stephan Kneer, Farchant (DE); Kasim Yilginc, Oberammergau (DE); Johannes Tschirkow, Weilheim (DE); Randolf Schierlein, Peiting (DE); Maximilian Haseidl, Bad Kohlgrub (DE)

(21) Appl. No.: 18/334,290

(22) Filed: Jun. 13, 2023

(30) Foreign Application Priority Data
Jul. 7, 2022 (DE) 102022116966.9

(51) Int. Cl. B29C 49/22; B29C 49/04

(52) U.S. Cl. CPC B29C 49/22; B29C 49/04; B29C 2793/0045; B29L 2031/712

(57) ABSTRACT

A method of manufacturing a usable container that includes supplying, by a first screw conveyor, a first thermoplastic plastic material for the outer container to an extruder, supplying, by at least one second screw conveyor, at least one second thermoplastic plastic material for the inner bag to the extruder, cutting at least two, preferably diametrically opposed, holes in the outer container at a lower edge region of a shoulder section, inserting pins vertically through the holes, between the inner bag and the outer container to loosen the inner bag from the inner wall of the outer container, exerting an increased pressure from an exterior through the holes onto the inner bag, or producing a reduced pressure in the inner bag to detach the inner bag from an inner wall of the outer container.

### PRIORITY CLAIM

The subject application claims convention priority to German patent application No. DE 10 2022 116 966.9, filed Jul. 7, 2022.

### BACKGROUND

The invention relates to a method of manufacturing a usable container consisting of a stiff outer container and a deformable inner bag, wherein a first screw conveyor supplies a first thermoplastic plastic material for the outer container to an extruder and at least one second screw conveyor supplies at least one second thermoplastic plastic material for the inner bag to the extruder, which coextrudes a preform, which is arranged between the open halves of a blow mould of a blow moulder, wherein the blow mould is closed when the preform has the length necessary for the manufacture of a container, wherein excess material in the base region of the container to be manufactured is squeezed out and a web is formed of material of the outer container, in which the welded base seam of the inner bag is clamped, and wherein the preform is inflated by a pressure medium into engagement with the wall of the blow mould, the excess material below the weld seam is severed and the container is removed from the blow mould.

Such a method has long been known, wherein openings are formed in the outer container, for instance by a circular cutter. When the contents of the container are discharged from the inner bag, ambient air flows through these wall openings into the gap between the outer container and the inner bag for the purpose of pressure balance so that the inner bag can contract.

The different thermoplastic plastic materials of the outer container and the inner bag do not form a weld connection with one another but they adhere to one another when the container is manufactured in accordance with the method described above in a coextrusion process. Before such a container is usable, i.e. is filled with a liquid or, for instance, pasty container content, which is then gradually discharged, e.g. by means of an Airless pump or by compressing the container, the inner bag must be detached from the wall of the outer container and then applied to it again. This can be effected by applying a reduced pressure through the container opening to the inner bag, which thereafter abruptly contracts. Compressed air can subsequently be introduced through the container opening into the inner bag in order to apply it again to the outer container. If the inner bag is not detached substantially uniformly from the wall of the outer container, a relatively large reduced pressure occurs in the inner bag when filling material is dispensed despite pressure balancing openings in the wall of the outer container, whereby the functionality of a pump, which is generally provided, can be impaired. In this event, a proportion of the filling material cannot be discharged.

### SUMMARY

The previously known methods for detaching the inner bag from the container wall and the subsequent application to the wall of the outer container are time-consuming and increase the manufacturing time of usable containers of the type under consideration. Furthermore, it has transpired that with bottle-shaped containers problems can occur with the detaching process in the shoulder region.

It is the object of the present invention to provide a method with which the detaching process of the inner bag occurs with greater reliability and a smaller time requirement.

The invention provides that, in a first step, at least two, preferably diametrically opposed, holes are cut in the outer container at the lower edge region of the shoulder section. This can be done with a circular knife cut performed along a circular path, in which it is ensured that the inner bag is not thereby damaged. The two holes are preferably situated diametrically opposite to one another but can also be offset from one another at an angle differing from 180°.

The invention provides, as the next step, that pins are introduced through the holes, preferably vertically, between the inner bag and the outer container in order to loosen the inner bag from the inner wall of the outer container. The term “loosen” refers to the small area in which the pins mechanically lift the inner bag away from the outer container. Conveniently, two pins are introduced in this manner through the two holes.

The invention provides, as the next step, that an increased pressure is exerted from the exterior through the holes onto the inner bag and/or a reduced pressure is produced in the inner bag in order to detach the inner bag over a large area or over its entire area from the inner wall of the outer container. Surprisingly, it has transpired that this detaching process can occur considerably more rapidly and in a single cycle after the “loosening” by the pins whilst with the conventional method without “loosening” a considerably longer action of increased pressure or reduced pressure is necessary. Furthermore, the method in accordance with the invention effects a reliable detaching of the inner bag over its entire area in the particularly difficult shoulder region.

The pins are preferably introduced vertically, whereby they can also be introduced at an angle to the vertical between the inner bag and the outer container.

The pins are inserted only a short distance, preferably about five to fifteen millimetres, between the inner bag and the outer container, whereby the optimal insertion depth depends on, amongst other things, the size of the bottle. The optimum depth may be readily determined by experiments.

In order that the inner bag is not damaged in this process, pegs should be used which have smooth, rounded head ends.

It has further transpired that a relatively smaller increased pressure is sufficient to detach the inner bag whilst in conventional detaching methods an increased pressure which is approximately twice as large is used. When the detaching process is effected by reduced pressure in the inner bag, a lesser reduced pressure is advantageously produced in the inner bag.

It is further proposed with advantage that the two first method steps are performed in a cutting station of a detaching machine. For this purpose, the cutting station includes, in accordance with a further aspect of the invention, means for driving two knives, preferably circular knives, in order to cut the holes in the outer container, and means for advancing two pins, preferably ejector pins, which are introduced through the holes in a container fixed in position in the cutting station.

The final detaching process is performed in a detaching station of the detaching machine, whereby the detaching machine should be connected to the blow moulder so that containers which have not yet completely cooled may be further processed in the detaching machine.

### BRIEF DESCRIPTION OF THE DRAWINGS

FIG. 1A is a side view of an outer container 1 with a hole 3 cut in the outer container 1 at the lower edge region of the shoulder section 2. The sectional view B-B of FIG. 1B shows that two such holes 3 are cut situated diametrically opposite to one another in the lower edge region of the shoulder section 2. An ejector pin 4 is shown above the holes 3 in a starting position. In FIG. 2A, the pin 4 is advanced through a hole between the inner bag and the outer container, whereby the inner bag is detached in this region from the inner wall of the outer container. This is shown in the sectional view A-A of FIG. 2B.

### DETAILED DESCRIPTION

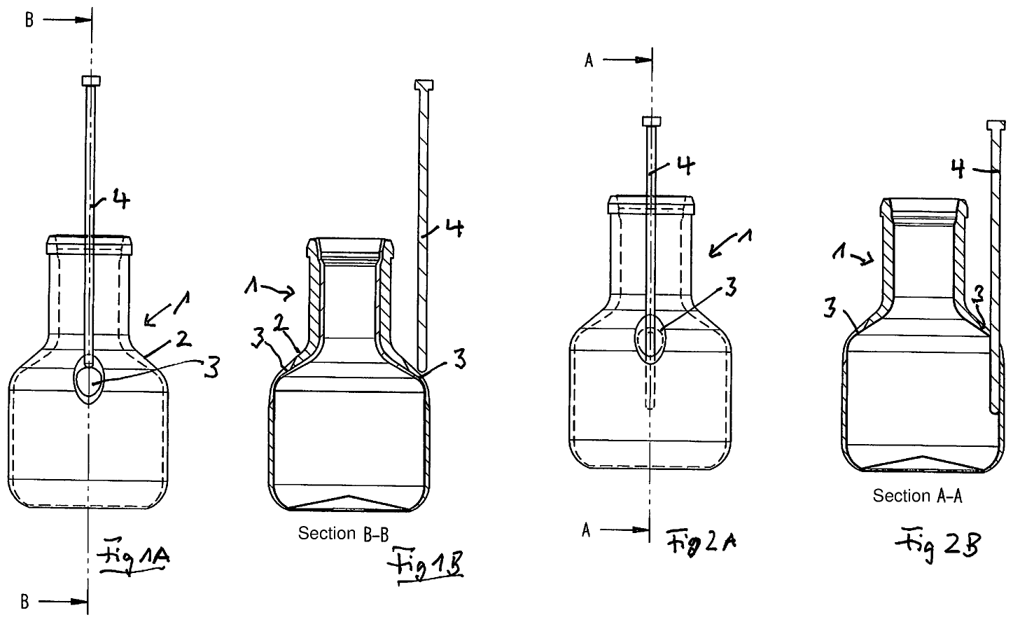

FIG. 1A is a side view of an embodiment of an outer container.

FIG. 1B is a cross-sectional view of the outer container of FIG. 1A taken along line B-B in the direction generally indicated.

FIG. 2A is a side view of the outer container of FIG. 1A having a pin advanced through a hole between an inner bag and the outer container.

FIG. 2B is a cross-sectional view of the outer container of FIG. 2A taken along line A-A in the direction generally indicated.

1. A method of manufacturing a usable container consisting of a stiff outer container and a deformable inner bag, the method comprising:
supplying, by a first screw conveyor, a first thermoplastic plastic material for the outer container to an extruder;
supplying, by at least one second screw conveyor, at least one second thermoplastic plastic material for the inner bag to the extruder, which coextrudes a preform, which is arranged between the open halves of a blow mold of a blow molder, wherein the blow mold is closed when the preform has a length necessary for the manufacture of the container, wherein excess material in a base region of the container to be manufactured is squeezed out and a web is formed from material of the outer container, in which the welded base seam of the inner bag is clamped, and wherein the preform is inflated by a pressure medium into engagement with the wall of the blow mold, the excess material beneath the weld seam is severed and the container is removed from the blow mold;
cutting at least two, preferably diametrically opposed, holes in the outer container at a lower edge region of a shoulder section;
inserting pins vertically through the holes, between the inner bag and the outer container to loosen the inner bag from the inner wall of the outer container;
exerting an increased pressure from an exterior through the holes onto the inner bag, or
producing a reduced pressure in the inner bag to detach the inner bag from an inner wall of the outer container.

2. A method as claimed in claim 1, wherein the pins are introduced a short distance of about 5 to 15 mm between the inner bag and the outer container.

3. A method as claimed in claim 1, wherein the pins are used with rounded head ends.

4. A method as claimed in claim 1, wherein an increased pressure is applied externally.

5. A method as claimed in claim 1, wherein a reduced pressure is applied in the inner bag.

6. A method as claimed in claim 1, wherein the cutting and inserting are performed in a cutting station of a detaching machine.

7. A method as claimed in claim 1, wherein the producing is performed in a detaching station of the detaching machine.

8. A method as claimed in claim 1, wherein the detaching machine is connected to the blow molder so that containers which are still warm may be further processed in the detaching machine.
